(19) United States
(12) Patent Application Publication
(10) Pub. No.: US 2016/0313579 A1
(43) Pub. Date: Oct. 27, 2016

(54) ELECTRO-OPTIC ELEMENT

(71) Applicants: SUMITOMO OSAKA CEMENT CO., LTD., Tokyo (JP); KYUSHU UNIVERSITY, NATIONAL UNIVERSITY CORPORATION, Fukuoka-shi (JP); NISSAN CHEMICAL INDUSTRIES, LTD., Tokyo (JP)

(72) Inventors: Shiyoshi YOKOYAMA, Fukuoka-shi (JP); Feng QIU, Fukuoka-shi (JP); Junichiro ICHIKAWA, Tokyo (JP); Satoshi OIKAWA, Tokyo (JP); Youichi HOSOKAWA, Tokyo (JP); Daisuke MAEDA, Funabashi-shi (JP)

(21) Appl. No.: 15/103,824

(22) PCT Filed: Dec. 11, 2014
(86) PCT No.: PCT/JP2014/082903

§ 371 Date: Jun. 10, 2016

(30) Foreign Application Priority Data
Dec. 11, 2013 (JP) 2013-256545

(51) Int. Cl. G02F 1/065; G02F 1/01; G02F 1/365

(52) U.S. Cl. CPC G02F 1/065; G02F 1/365; G02F 1/0102; G02F 2201/12

(57) ABSTRACT

The present invention provides an electro-optic element including an optical waveguide that is constituted of a core layer made of an inorganic compound and a first clad layer and a second clad layer which are laminated so as to sandwich the core layer therebetween and are made of a dielectric material, and a first electrode layer and a second electrode layer that are formed so as to sandwich the core layer therebetween, the first clad layer, and the second clad layer, in which at least one of the first clad layer and the second clad layer contains an organic dielectric material having an electro-optic effect, and refractive indices of the first clad layer and the second clad layer are lower than a refractive index of the core layer.

### TECHNICAL FIELD

The present invention relates to an electro-optic element and, more specifically, to an electro-optic element that is preferably used for long-distance optical communication in which optical fibers are used.

The present application claims priority on the basis of Japanese Patent Application No. 2013-256545, filed on Dec. 11, 2013, the content of which is incorporated herein.

### BACKGROUND ART

In recent years, in accordance with the advancement of high-speed and high-capacity optical fiber communication systems, as represented by external modulators, optical modulators in which waveguide-type optical elements are used have been put into practical use and have become widely used.

As the above-described optical modulators, optical modulators in which non-linear optic metal oxides such as lithium niobate (LiNbO₃, in some cases, also abbreviated as LN) or lithium tantalate (LiTaO₃) having an electro-optic effect are used have been proposed and have been put into practical use (Patent Literature No. 1). In addition, optical modulators in which non-linear optically active polymers are used have also been proposed (Patent Literature No. 2).

### CITATION LIST

### Patent Literature

[Patent Literature No. 1] Japanese Laid-open Patent Publication No. 2000-056282

[Patent Literature No. 2] Japanese Laid-open Patent Publication No. 2009-98195

### Non Patent Literature

[Non Patent Literature No. 1] Yamamoto et al., “Electro-optic polymer waveguides with low-resistivity polymer cladding, ” Proceedings of The 59^{th} JSAP Spring Meeting, 18a-GP4-1 2012

### SUMMARY OF INVENTION

### Technical Problem

Meanwhile, in optical modulators of the related art in which non-linear optic metal oxides such as lithium niobate (LiNbO₃) are used, while high-speed modulation is possible, due to the low electro-optic coefficient of non-linear optic metal oxides and, furthermore, a large refractive index dispersion and a large permittivity dispersion, there has been a problem in that high-speed modulation is not possible in high-frequency bands higher than 10 GHz.

In addition, since the non-linear optic metal oxides are single crystals, there has been a problem in that thickness reduction, integration, and miniaturization of optical modulators are difficult.

Meanwhile, in optical waveguide elements in which non-linear optically active polymers are used, the refractive index dispersion and the permittivity dispersion are small, and modulation operations in high-frequency bands are relatively easy. In the related art, in optical waveguide elements in which non-linear optically active polymers are used, non-linear optically active polymers have been used for the core portions of optical waveguides having a high optical field intensity. In order to make optical waveguide elements function as optical waveguides, it is essential to select materials having a smaller refractive index than that of the materials of the core portions as materials for clad portions, and furthermore, it is necessary to select materials having little light absorption or scattering. In addition, in this constitution, in order to make non-linear optically active polymers efficiently develop an electro-optic effect, it is necessary to select materials for clad portions which have a smaller electrical resistance value (None Patent Literature No. 1). Therefore, the low electrical resistivity of non-linear optically active polymers having high performance extremely limits the kinds of clad material. Although sol-gel-based materials and the like having resistance values that can be adjusted by the addition of impurites are also used, there have been problems in that non-linear optically active polymers are degraded due to thermal treatments necessary for the formation of sol-gel material films, and it is difficult to obtain reproducibility of optical characteristics or electrical characteristics of films, and the like.

The present invention has been made in order to solve the above-described problems, and an object of the present invention is to provide an electro-optic element enabling high-speed modulation even in high-frequency bands higher than 10 GHz and, furthermore, enabling integration, miniaturization, and power consumption reduction.

### Solution to Problem

The present inventors and the like carried out intensive studies in order to solve the above-described problems and, consequently, found that, in an electro-optic element in which an optical waveguide is constituted of a core layer made of an inorganic compound and a first clad layer and a second clad layer which are laminated so as to sandwich the core layer and are made of a dielectric material, and a first electrode layer and a second electrode layer are formed so as to sandwich the core layer, the first clad layer, and the second clad layer, when an organic dielectric material having an electro-optic effect is added to at least one of the first clad layer and the second clad layer, and the refractive indices of the first clad layer and the second clad layer are set to be lower than the refractive index of the core layer, due to a high electro-optic coefficient of the organic dielectric material included in the clad layers and the small refractive index dispersion and the small permittivity dispersion, high-speed modulation is possible even in high-frequency bands higher than 10 GHz and completed the present invention.

In other words, an electro-optic element of the present invention is an electro-optic element including an optical waveguide that is constituted of a core layer made of an inorganic compound and a first clad layer and a second clad layer which are laminated so as to sandwich the core layer therebetween and are made of a dielectric material, and a first electrode layer and a second electrode layer that are formed so as to sandwich the core layer therebetween, the first clad layer, and the second clad layer, in which at least one of the first clad layer and the second clad layer contains an organic dielectric material having an electro-optic effect, and refractive indices of the first clad layer and the second clad layer are lower than a refractive index of the core layer.

Film thicknesses of the first clad layer and the second clad layer are preferably thicker than a film thickness of the core layer.

The inorganic compound preferably contains one or two or more selected from of the group consisting of titanium oxide, silicon nitride, niobium oxide, tantalum oxide, hafnium oxide, aluminum oxide, silicon, diamond, lithium niobate, lithium tantalate, potassium niobate, barium titanate, KTN, STO, BTO, SBN, KTP, PLZT, and PZT.

The first electrode layer and the second electrode layer preferably contain one or two or more selected from the group consisting of gold, silver, copper, platinum, ruthenium, rhodium, palladium, osmium, iridium, and aluminum.

The organic dielectric material is preferably a non-linear optic organic compound.

It is preferable that anyone of the first electrode layer and the second electrode layer has a strip shape and a voltage is applied between the first electrode layer and the second electrode layer, whereby an electric field is applied to the optical waveguide as a microstrip-type electrode or a stacked pair-type electrode, and any one or both of phase and mode shape of light propagating through the optical waveguide is controlled. Furthermore, a shield-shaped third electrode may be provided so as to form a stripline shape or form a shielded microstripline shape or a shielded stacked pair line shape.

It is preferable that any one of the first electrode layer and the second electrode layer has a coplanar shape and a voltage is applied between the first electrode layer and the second electrode layer, whereby an electric field is applied to the optical waveguide as a G-CPW-type electrode, and any one or both of the phase and mode shape of the light propagating through the optical waveguide is controlled.

### Advantageous Effects of Invention

According to the electro-optic element of the present invention, the organic dielectric material having an electro-optic effect is added to at least one of the first clad layer and the second clad layer, and the refractive indices of the first clad layer and the second clad layer are set to be lower than the refractive index of the core layer, and thus the electro-optic coefficient of the organic dielectric material included in the clad layers becomes large, and the refractive index dispersion and the permittivity dispersion become small, and thus it is possible to carry out high-speed modulation even in high-frequency bands higher than 10 GHz.

In addition, since at least one of the first clad layer and the second clad layer contains the organic dielectric material having an electro-optic effect, the organic dielectric material is capable of coping with additional integration and miniaturization, and thus the integration, miniaturization, and power consumption reduction of the electro-optic element can be achieved.

### BRIEF DESCRIPTION OF DRAWINGS

FIG. 1 is a plan view illustrating an electro-optic element of a first embodiment of the present invention.

FIG. 2 is a sectional view in a direction of line A-A in FIG. 1.

FIG. 3 is a sectional view illustrating a modification example of an optical waveguide structure (active portion) of the electro-optic element of the first embodiment of the present invention.

FIG. 4 is a sectional view illustrating a modification example of the optical waveguide structure (active portion) of the electro-optic element of the first embodiment of the present invention.

FIG. 5 is a sectional view illustrating a structure of an electro-optic element of a second embodiment of the present invention.

FIG. 6 is a sectional view illustrating a modification example of an electrode structure of the electro-optic element of the second embodiment of the present invention.

FIG. 7 is a sectional view illustrating a modification example of an optical waveguide structure (active portion) of the electro-optic element of the second embodiment of the present invention.

FIG. 8 is a sectional view illustrating a modification example of an electrode structure of the electro-optic element of the second embodiment of the present invention.

FIG. 9 is a sectional view illustrating a modification example of the optical waveguide structure (active portion) of the electro-optic element of the second embodiment of the present invention.

FIG. 10 is a sectional view illustrating an example of a parallel plate electrode type of an electro-optic element of a third embodiment of the present invention.

### DESCRIPTION OF EMBODIMENTS

Aspects for carrying out the electro-optic element of the present invention will be described on the basis of the accompanying drawings.

Meanwhile, these aspects are specific descriptions for the better understanding of the gist of the invention and do not limit the present invention unless particularly otherwise specified. For example, for the reasons in terms of manufacturing processes such as improvement in adhesion between materials, prevention of the reaction between materials, and changes in properties, a thin film body may be sandwiched between the core and the clad or between the clad and an electrode material. In addition, the respective layers may be constituted of compound materials made of thin film bodies.

### First Embodiment

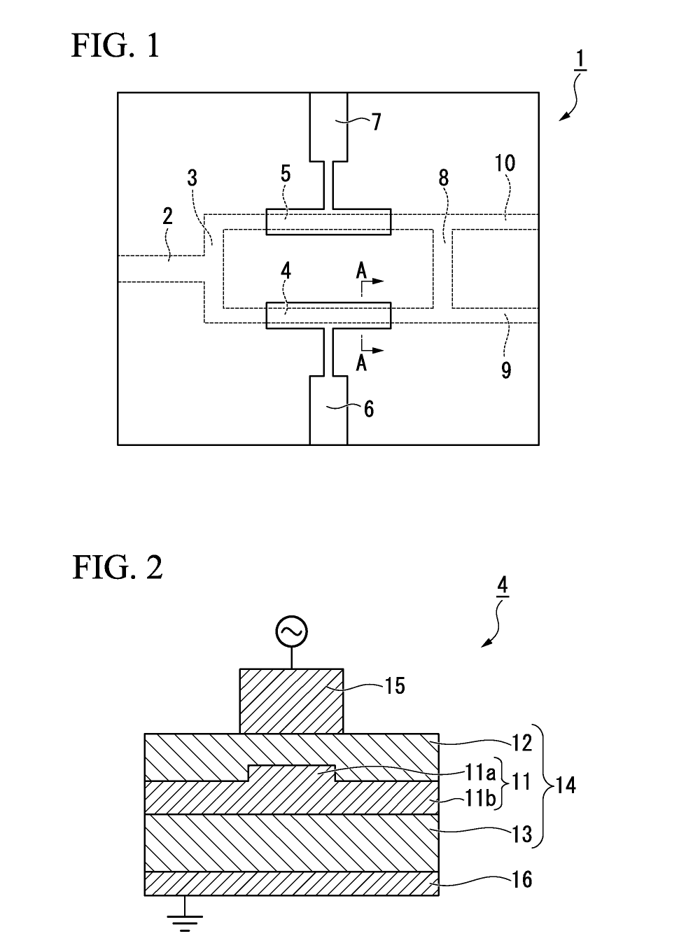

FIG. 1 is a plan view illustrating an electro-optic element of a first embodiment of the present invention, FIG. 2 is a sectional view in a direction of line A-A in FIG. 1, and the electro-optic element of the first embodiment will be described using an MMI-MZ optical switch provided with a microstrip-type electrode (hereinafter, simply abbreviated as the optical switch).

This optical switch 1 is an optical switch made of a thin film provided with a microstrip-type electrode and is constituted of an incidence-side optical waveguide (incidence side) 2, an optical branching portion 3 optically connected to the emission end of the optical waveguide (incidence side) 2, a pair of optical waveguides (active portions) 4 and 5 optically connected to the emission end of the optical branching portion 3, electrodes 6 and 7 respectively provided in these optical waveguides (active portions) 4 and 5 independently, an optical branching and multiplexing portion 8 optically connected to the emission ends of these optical waveguides (active portions) 4 and 5, and a pair of optical waveguides for optical output (emission side) 9 and 10 optically connected to the emission side of the optical branching and multiplexing portion 8.

As illustrated in FIG. 2, in the electro-optic element of the first embodiment, an optical waveguide structure portion 14 is constituted of a core layer 11 made of an inorganic compound and a (first) clad layer 12 and a (second) clad layer 13 which are laminated so as to sandwich the core layer 11 and are made of a dielectric material, and a (first) electrode layer 15 of a microstripline and a (second) electrode layer 16 made of a planar electrode are formed so as to sandwich the core layer 11, the clad layer 12, and the clad layer 13.

The core layer 11 is a thin film in which the film thickness of an optical waveguide region 11a is increased in a strip shape in a direction toward the electrode layer 15 so as to be thicker than the film thickness of a non-optical waveguide region 11b which is a region other than the optical waveguide region 11a. The core layer 11 contains an inorganic compound, for example, one or two or more selected from the group consisting of titanium oxide (TiO₂), silicon nitride (Si₃N₄), niobium oxide (Nb₂O₅), tantalum oxide (Ta₂O₅), hafnium oxide (HfO₂), aluminum oxide (Al₂O₃), silicon (Si), diamond (C), lithium niobate (LiNbO₃), lithium tantalate (LiTaO₃), potassium niobate (KNbO₃), barium titanate (BaTiO₃), KTN (K (TaₓNb₁₋ₓ) O₃), strontium titanate (SrTiO₃:STO), bismuth titanate (Bi₁₂TiO₂₀:BTO), SBN (SrₓBa₁₋ₓNb₂O₃), KTP (KTiOPO₄), PLZT (Pb₁₋ₓLaₓ(Zr_{y}Ti_{1-y})_{1-x/4}O₃), and PZT (Pb (ZrₓTi₁₋ₓ)_{1-x/4}O₃).

Among these inorganic compounds, when the electro-optic coefficient, the refractive index dispersion, and the permittivity dispersion are taken into account, titanium oxide (TiO₂), niobitum pentoxide (Ta₂O₅), tantalum pentoxide (Ta₂O₅), and the like, and materials including these as solid solution materials are preferred. In addition, in a case in which materials having an electro-optic effect such as lithium niobate (LiNbO₃) and lithium tantalate (LiTaO₃) are used as materials for the core layer 11, it is possible to further enhance the efficiency or functions of the element by making the electro-optic effect of the core portion material and the electro-optic effect of the clad portion material cooperate with each other.

The clad layers 12 and 13 are thin films sandwiching the core layer 11 from both sides in the film thickness direction, and at least one of these clad layers 12 and 13 contains an organic dielectric material having an electro-optic effect.

Meanwhile, in order to more efficiently develop the electro-optic effect, both the clad layers 12 and 13 preferably contain an organic dielectric material having an electro-optic effect.

The organic dielectric material having an electro-optic effect is preferably a non-linear optic organic compound, and the non-linear optic organic compound is preferably one of non-linear optic organic compounds (1) and (2) described below.

Non-Linear Optic Organic Compound (1):

Organic compounds containing a furan ring group represented by Chemical Formula (1) below.

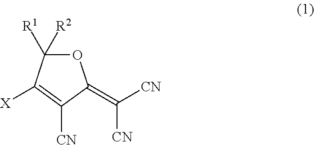

(In the formula, R¹ and R² are independent groups from each other, the respective groups are any ones of hydrogen atoms, alkyl groups having 1 to 5 carbon atoms, haloalkyl groups having 1 to 5 carbon atoms, and aryl groups having 6 to 10 carbon atoms, and X is an atomic bond with another organic compound.)

Examples of the organic compounds containing the furan ring group represented by Formula (1) include non-linear optic organic compounds represented by Chemical Formula (2) below.

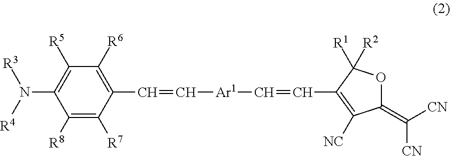

(In the formula, R³ and R⁴ are independent from each other and are any ones of hydrogen atoms, alkyl groups having 1 to 10 carbon atoms which may have substituents, and aryl groups having 6 to 10 carbon atoms which may have substituents, R⁵ to R⁸ are independent from each other and are any ones of hydrogen atoms, alkyl groups or hydroxyl groups having 1 to 10 carbon atoms, alkoxy groups having 1 to 10 carbon atoms, alkylcarbonyloxy groups having 2 to 11 carbon atoms, aryloxy groups having 4 to 10 carbon atoms, arylcarbonyloxy groups having 5 to 11 carbon atoms, silyloxy groups having alkyl groups having 1 to 6 carbon atoms and phenyl groups, silyloxy groups having alkyl groups having 1 to 6 carbon atoms or phenyl groups, and halogen atoms, and Ar¹ is a divalent aromatic group.)

Here, the divalent aromatic group Ar¹ is preferably a divalent aromatic group represented by Chemical Formula (3) or (4) below.

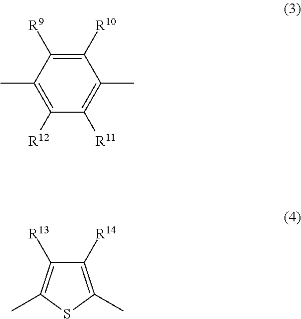

(In Formula (3) or (4) , R⁹ to R¹⁴ are independent from each other and are any ones of hydrogen atoms, alkyl groups having 1 to 10 carbon atoms which may have substituents, and aryl groups having 6 to 10 carbon atoms which may have substituents.)

Non-Linear Optic Organic Compound (2):

Non-linear optically active polymers including a repeating unit represented by Chemical Formula (5) below.

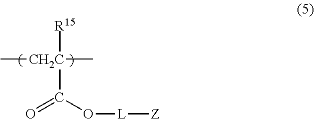

(In the formula, R¹⁵ is a hydrogen atom or a methyl group, L is a divalent hydrocarbon group having 1 to 30 carbon atoms, and Z is an atomic group developing non-linear optic activity.)

This divalent hydrocarbon group may have an ether group, an ester group, an amide group, or the like.

Examples of the atomic group Z developing non-linear optic activity include atomic groups having a furan ring group represented by Chemical Formula (6) below.

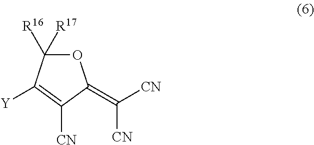

(In the formula, R¹⁶ and R¹⁷ are independent from each other and are any ones of hydrogen atoms, alkyl groups having 1 to 5 carbon atoms, haloalkyl groups having 1 to 5 carbon atoms, and aryl groups having 6 to 10 carbon atoms, and Y is an atomic bond.)

In addition, examples of the atomic group Z developing non-linear optic activity include atomic groups derived from organic compounds represented by Chemical Formula (7) below.

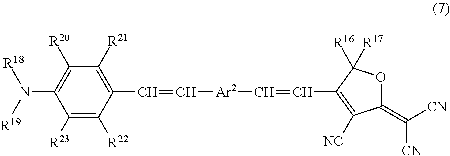

(In the formula, R¹⁸ and R¹⁹ are independent from each other and are any ones of hydrogen atoms, alkyl groups having 1 to 10 carbon atoms which may have substituents, and aryl groups having 6 to 10 carbon atoms which may have substituents, R²⁰ to R²³ are independent from each other and are any ones of hydrogen atoms, alkyl groups having 1 to 10 carbon atoms, hydroxyl group, alkoxy groups having 1 to 10 carbon atoms, alkylcarbonyloxy groups having 2 to 11 carbon atoms, aryloxy groups having 4 to 10 carbon atoms, arylcarbonyloxy groups having 5 to 11 carbon atoms, silyloxy groups having alkyl groups having 1 to 6 carbon atoms and phenyl groups, silyloxy groups having alkyl groups having 1 to 6 carbon atoms or phenyl groups, and halogen atoms, and Ar² is a divalent aromatic group.)

The substituents may be groups capable of reacting with isocyanate groups.

Here, the divalent aromatic group Ar² is preferably a divalent aromatic group represented by Chemical Formula (8) or (9) below.

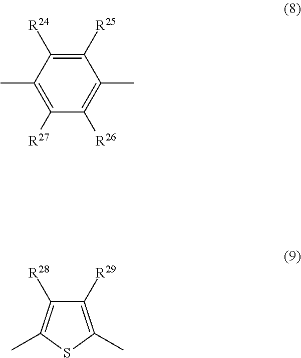

(In Formula (8) or (9), R²⁴ to R²⁹ are independent from each other and are any ones of hydrogen atoms, alkyl groups having 1 to 10 carbon atoms which may have substituents, and aryl groups having 6 to 10 carbon atoms which may have substituents.)

The substituents may be groups capable of reacting with isocyanate groups.

In the optical waveguide structure portion 14, the refractive indices of the clad layers 12 and 13 are set to be lower than the refractive index of the optical waveguide region 11a in the core layer 11.

For example, titanium oxide (TiO₂; a refractive index n=2.2) is used for the core layer 11, and non-linear optically active polymers represented by Chemical Formulae (2) and (3) (refractive indices n=1.61) are used for the clad layers 12 and 13.

In the optical waveguide structure portion 14, the film thicknesses of the clad layers 12 and 13 are set to be thicker than the film thickness of the optical waveguide region 11a in the core layer 11.

For example, in a case in which titanium oxide (TiO₂; a refractive index n=2.2) is used for the core layer 11, non-linear optically active polymers represented by Chemical Formulae (2) and (3) above (refractive indices n=1.61) are used for the clad layers 12 and 13, the film thickness of the optical waveguide region 11a in the core layer 11 is set to a range of 0.1 μm to 0.5 μm, and the film thicknesses of the clad layers 12 and 13 are set to a range of 1 μm to 5 μm, it is possible to satisfy both single mode propagation of light and the efficient application of high electric fields between electrodes to optical electric fields leaking to the clads made of non-linear optically active polymers in communication wavelength bands.

In the optical waveguide structure portion 14, since the non-linear optic organic compound is included in at least one of the clad layers 12 and 13, by applying an electric field to the clad layer 12 (13) including the non-linear optic organic compound at a temperature near the glass transition temperature Tg of the non-linear optic organic compound, and polling organic molecules in the non-linear optic organic compound in the clad layer 12 (13), it is possible to add an electro-optic effect (EO effect) to this non-linear optic organic compound.

In order to add a high electro-optic coefficient (EO coefficient) to this non-linear optic organic compound, while it depends on the kind of the non-linear optic organic compound, generally, a treatment for applying a high electric field of 50 V/μm or higher, preferably 80 V/μm or higher, to the clad layer 12 (13) at a temperature near the glass transition temperature Tg of the non-linear optic organic compound (polling treatment) is required.

In such a case, the clad layer 12 (13) develops an electro-optic effect (Pockels effect) and obtains an electro-optic coefficient (EO coefficient).

In the optical waveguide structure portion 14, from the ordinary viewpoint of the efficiency of the polling treatment, the electrical resistivity at a temperature near the glass transition temperature Tg of the clad layer 12 (13) is preferably higher than the electrical resistivity of the core layer 11 and is more preferably set to be ten or more times higher in terms of resistivity.

Here, the reason for the electrical resistivity of the core layer 11 at a temperature near Tg preferably satisfying the above-described condition is to effectively apply electric fields to the clad portions made of non-linear optically active polymers during the polling treatment for developing the electro-optic effect in the clad layers. A voltage applied during the poling treatment is a direct-current or low-frequency signal, circuits made up of the core layer (11) and the clad layer 12 (13) can be considered as series circuits of resistors, and voltages applied to individual portions are determined by the balance of the resistance values of the individual portions, that is, the products between the resistivity and the film thicknesses of the individual portions. In a case in which the resistivity of the clad layer 12 (13) is higher than the resistivity of the core layer 11, the voltage applied to the clad portion becomes relatively high, and thus the electric field efficiency in the clad portion becomes high, and the polling treatment can be effectively carried out.

In contrast, when the resistivity of the core layer 11 at a temperature near Tg is higher than the resistivity of the portion of the clad layer 12 (13) made of non-linear optically active polymers, the voltage applied to the core layer 11 becomes relatively high, and the voltage applied to the clad layer 12 (13) becomes relatively low. Accordingly, it becomes difficult to effectively apply a polling electric field to non-linear optically active polymer portions during the polling treatment, and thus the voltage necessary for the polling treatment becomes high. However, when a high voltage is applied during the polling treatment, the risk of element breakdown due to discharging or dielectric breakdown is increased.

In contrast, in the constitution of the optical waveguide structure portion 14 according to the present embodiment, the thickness of the core layer 11 is thin, and thus, even in a case in which the electrical resistivity of the clad layer 12 (13) at a temperature near the glass transition temperature Tg is lower than the electrical resistivity of the core layer 11, the voltage applied to the core layer 11 becomes relatively low. Therefore, a sufficient amount of voltage is applied even to the clad layer 12 (13), and thus it is possible to carry out the polling treatment even at a low voltage.

Meanwhile, at an operation temperature of the element, when the resistivity of at least one of the clad layers 12 and 13 is approximately identical to or lower (1×10⁵ Ωm or lower) than the resistivity of semiconductors, losses of high-frequency signals or losses of light caused by the migration of carriers in materials cannot be ignored, and thus the materials selected are not preferable. This fact is also valid to the core layer 11.

In a case in which one of these clad layers 12 and 13 contains an organic dielectric material having an electro-optic effect, the other may contain a dielectric material made of a sol-gel substance.

Examples of the dielectric material made of a sol-gel substance include SiO₂-based dielectric materials, SiO₂-based dielectric materials to which Zr, Ti, or the like is added in order to adjust the conductive properties or the refractive index, and the like.

For the electrode layers 15 and 16, it is practically desirable to use materials having favorable conductive properties at high frequencies, for example, materials containing one or two or more selected from the group consisting of gold (Au), silver (Ag), copper (Cu), platinum (Pt), ruthenium (Ru), rhodium (Rh), palladium (Pd), osmium (Os), iridium (Ir), and aluminum (Al).

The materials for the electrode layers 15 and 16 are not limited to metals as long as the materials have favorable conductive properties. Although there is a limitation regarding the operation temperature of the element, superconducting materials may also be used. In order to increase electric fields of high frequency signals applied to the optical waveguide structure portion 14, it is effective to thin the clad layer 12 (13) and narrow the gap between the electrode 6 and the electrode 7, but an increase in the loss of light propagating through the optical waveguide structure portion 14 is caused. As a method for reducing the loss of light, it is also possible to use a conductive material having both a small absorption loss of light and favorable conductive properties, that is, a transparent electrode for the electrode layer 15 or the electrode layer 16. The above-described conductive material is preferably a transparent electrode made of tin-added indium oxide (indium tin oxide: ITO), antimony-doped tin oxide (antimony tin oxide: ATO), tin oxide (SnO₂), or the like.

Regarding the distribution of voltages to the core layer 11 and the clad layer 12 (13) with respect to high-frequency signals, the element structure of the present invention can be considered as a series circuit of capacitors by treating the respective layers as capacitors. The distribution of voltages applied to the respective layers is determined by the capacities of the respective capacitors, that is, the ratio between the permittivity and the film thicknesses of the respective layers. Compared with the clad layer 12 (13), the core layer 11 has greater permittivity and a thinner film thickness and thus has a great capacity as a capacitor. Therefore, a relatively small amount of voltage with high-frequency signals is distributed to the core layer 11, and a majority of the voltage is applied to the clad portions. Since elements having the present constitution operate on a principle in which the refractive index of the portion of the clad layer 12 (13) made of non-linear optically active polymers changes according to external electric fields from high-frequency signals, a high voltage in the portion of the clad layer 12 (13) advantageously works.

The film thicknesses of these electrode layers 15 and 16 are preferably 0.05 μm or greater and 50 μm and more preferably 0.3 μm to 20 μm.

Here, when the film thicknesses of these electrode layers 15 and 16 are smaller than 0.05 μm, high-frequency signals significantly attenuate due to skin resistance in high-frequency signals, which is not preferable. On the other hand, when the film thicknesses of the electrode layers 15 and 16 exceed 20 μm, losses of high-frequency signals become low, but stress and strain caused by the difference in linear expansion coefficients between the core layer and the clad layers cause peeling of the electrodes, changes in the refractive index of the core or the clad, or changes in the effective optical path length of the optical waveguide, which are not preferable.

The width of the electrode layer 15 needs to be wider than the width of the strip-shaped optical waveguide region 11a in the core layer 11 in order to ensure favorable electric field efficiency. In addition, in order to obtain the favorable high-frequency response of the element, the width and height of the electrode need to be designed in consideration of the width of the optical waveguide region 11a, the permittivity and thicknesses of the core layer and the clad layers so as to obtain characteristic impedances suitable for high-frequency lines.

In this optical switch 1, when a voltage is applied between the electrode layers 15 and 16, an electric field is applied to the optical waveguide 4 by a microstrip-type electrode, and it is possible to control any one or both of the phase and mode shape (optical electric field distribution) of light propagating through the optical waveguide (active portion) 4. In a case in which the voltage is low, it is possible to consider that a change in the mode shape is negligibly-small and, substantially, only the phase shifts. In a case in which the voltage is high, both the phase and mode shape of light change. This phenomenon is attributed to the electro-optic effect of materials used for the core or the clads and functions at broadband frequencies from direct currents to terahertz bands.

First, when launched light is launched on the optical waveguide (incidence side) 2, this launched light is branched into light rays in two directions at the optical branching portion 3, these branched light rays are launched on the optical waveguide (active portion) 4 and the optical waveguide (active portion) 5. In the optical waveguide (active portion) 4 and the optical waveguide (active portion) 5, the electric field of the propagating light is not only distributed inside the optical waveguide region 11a in the core layer 11, but the light also leaks into the clad layers 12 and 13. Accordingly, the effective refractive index of the mode of the light propagating through the optical waveguide region 11a portion in the core layer 11 or the electric field distribution of the light is determined by the refractive index or thickness of the core layer 11, the refractive index, size, or shape of the optical waveguide region 11a, the refractive indices of the clad layers 12 and 13, and the like. Even when the thicknesses or shapes of the respective portions do not change, if the refractive indices of any portions are changed by the application of external electric fields, the effective refractive index of the mode of light propagating through the optical waveguide region 11a or the electric field distribution of light changes.

Here, in a case in which a voltage is applied only to the optical waveguide (active portion) 4, and no voltage is applied to the optical waveguide (active portion) 5, the effective refractive index of the optical waveguide region 11a in the core layer 11 in the optical waveguide (active portion) 4 changes in accordance with the amplitude and the polarity of the applied voltage. Therefore, when light propagates through the optical waveguide region 11a having this changed refractive index, the phase of the light propagating through the optical waveguide region 11a advances or delays. Whether the phase advance or delay is determined by the polarity of a voltage being applied, and the phase shift amount of the light is determined by the amplitude of the voltage. Consequently, it is possible to freely change the phase shift amount of light by controlling the amplitude and the polarity of the voltage.

Meanwhile, since no voltage is applied to the optical waveguide (active portion) 5, the refractive index of the optical waveguide region in the core layer in the optical waveguide (active portion) 5 does not become high, and the same refractive index as before the application of a voltage is maintained. Therefore, even when light propagates through the optical waveguide region, the phase of light propagating through the optical waveguide region does not shift.

When the voltage applied to the optical waveguide (active portion) 4 is controlled, and light having a phase delay by a half-wavelength and light having an unchanged phase are launched on the optical branching and multiplexing portion 8, these light rays are cancelled by mutual interference, and the output of light emitted from the optical branching and multiplexing portion 8 reaches “0”.

In addition, in a case in which a voltage is not applied to the optical waveguides 4 and 5, the effective refractive index of the optical waveguide region 11a in the core layer 11 does not change, and the same effective refractive index as before the application of a voltage is maintained. Therefore, even when light propagates through the optical waveguide region, the velocity (or phase) of the light propagating through the optical waveguide region does not change.

As described above, when two light rays having unchanged velocities (or phases) are launched on the optical branching and multiplexing portion 8, these light rays overlapp with each other by mutual interference, and the output of light emitted from the optical branching and multiplexing portion 8 reaches “1”.

For what has been described above, in the optical switch 1, it is possible to turn the output of light emitted from the optical branching and multiplexing portion 8 on and off by turning the voltage between the electrode layers 15 and 16 on and off.

Meanwhile, when the optical branching and multiplexing portion 8 and the optical waveguides (emission side) 9 and 10 are appropriately designed, it is also possible to carry out an operation of switching the output destination of light to anyone of the optical waveguides (emission side) 9 and 10 instead of an operation of turning the above-described intensity of optical output on and off.

As described above, according to the optical switch 1 of the present embodiment, since the organic dielectric material having an electro-optic effect is added to the clad layers 12 and 13, and the refractive indices of the clad layers 12 and 13 are set to be lower than the refractive index of the core layer 11, the electro-optic coefficient of the organic dielectric material included in the clad layers 12 and 13 is high, and the refractive index dispersion and the permittivity dispersion are small, and thus it is possible to carry out high-speed modulation even in high-frequency bands higher than 10 GHz.

In addition, since the organic dielectric material having an electro-optic effect is added to the clad layers 12 and 13, the organic dielectric material is capable of coping with additional integration and miniaturization, and thus the integration, miniaturization, and power consumption reduction of the electro-optic element can be achieved.

In order to verify the efficiency and manufacturability of the element, the element was fabricated by using TiO₂ for the core layer 11, polymethyl methacrylate (PMMA) containing an FTC-based pigment (C-60) as a non-linear optic polymer for the clad layer 12, and SiO₂ having no electro-optic effect for the clad layer 13 and setting the thickness of the non-optical waveguide region 11b to 0.15 μm, the thickness and width of the optical waveguide region 11a to 0.25 μm and 2.0 μm respectively, the thickness of the clad layer 12 to 4.0 μm, and the thickness of the clad layer 13 to 1.5 μm, the polling treatment was carried out, and the electro-optic coefficient r₃₃ of the clad layer 12 was estimated from the modulation characteristics of the element and was found to be 70 μm/V to 105 μm/V. This values of the electro-optic coefficient r₃₃ was higher than the electro-optic effect (approximately 60 μm/V) of a reference film prepared by forming a film of a non-linear optic polymer on an ITO film and carrying out the polling treatment, and thus it has been confirmed that a favorable polling treatment was carried out.

In the present embodiment, the optical waveguide structure portion 14 may be used as the optical waveguides (active portions) 4 and 5 in Mach-Zehnder interference-type optical ON/OFF or optical path-switching switches or may be used in ring waveguide portions or directional coupler portions in ring-type wavelength switches in wavelength-selective switches and the like.

For example, it has been confirmed that, when applied to ring waveguide-type wavelength switches having a diameter of 100 μm, the optical waveguide structure portion operated at a low power consumption of a switching voltage of 2 V. When the switching voltage is 2 V, it is not necessary to use compound semiconductor-type drivers for driving, and driving using low-power consumption and inexpensive SiGe-based drivers is possible. Improvement in efficiency such as changes in the designs of element structures or use of non-linear optic polymers in both clad layers 12 and 13 enables an additional decrease in the driving voltage. As described above, it has been confirmed that elements having the constitution of the present embodiment are practical elements which have small sizes and operate at high efficiencies.

In addition, while not illustrated herein, constitutions in which an overcoat layer on the electrode layer 15 is formed using materials having small dielectric losses and an earth electrode is formed on the overcoat layer, namely, stripline or shielded microstripline-shaped constitutions may be employed. The permittivity of low-permittivity materials is preferably small, and the specific permittivity thereof is preferably 3.0 or lower and desirably equal to or lower than the specific permittivity of a material used for the clad layers. It is also possible to form an earth electrode in the upper portion without providing low-permittivity layers. When the stripline or shielded microstripline-shaped constitutions are employed, the propagation losses of high-frequency signals are improved, and the degree of freedom in designing characteristic impedances or refractive indices (propagation velocities) with respect to microwaves are significantly improved.

Constitutions in which the earth electrode is not provided in the upper portion of the overcoat layer have advantages in terms of the prevention of peeling of the electrode layer 15 or the prevention of discharging during polling processes. In addition, an overcoat layer may be formed in order for characteristic impedances or refractive indices (propagation velocities) with respect to microwaves.

Since elements having the constitution of the present invention are driven not using the electrical signal strengths between the electrode layer 15 and the electrode layer 16 but using voltage differences, and thus, even when the electrical signal intensity is distributed in portions other than the optical waveguide structure portion 14, the efficiency does not decrease. It is an important point in terms of the design of the element to design electrode constitutions in which the propagation losses of electrical signals including high-frequency components are small.

In addition, a majority of the optical waveguide structure portion 14 is occupied by materials having a small refractive index dispersion and a small permittivity dispersion and thus designs of constitutions realizing the velocity matching between light and microwaves are relatively easy,however, the refractive index dispersions and the permittivity dispersions of materials suitable for the core layer 11 such as TiO₂, Nb₂O₅ and Ta₂O₅ are large and thus it is necessary to design the characteristics of the element in consideration of the characteristics of these materials. It is needless to say that, as devices driven at high frequencies, it is necessary to take characteristic impedances into account.

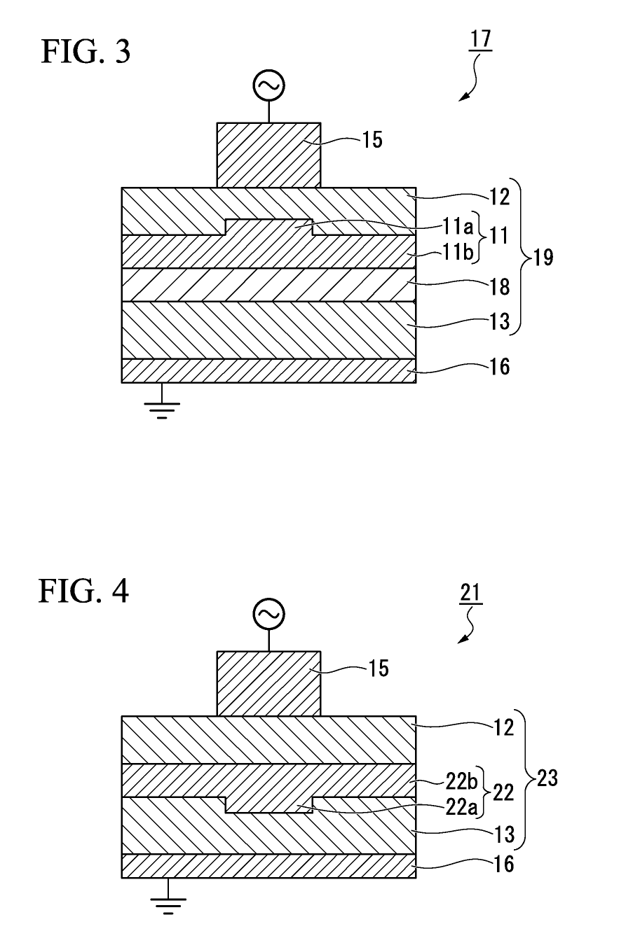

FIG. 3 is a sectional view illustrating a modification example of the optical waveguide structure (active portion) 4 of the optical switch 1 of the present embodiment. A difference of an active portion 17 having this microstrip-type electrode constitution of the optical switch from the above-described optical waveguide 4 in the optical switch 1 is that, while the above-described optical waveguide structure (active portion) 4 has a structure in which the core layer 11 and the clad layer 13 are closed attached together, the active portion 17 having the microstrip-type electrode constitution includes an optical waveguide structure portion 19 in which a protective layer 18 made of silicon oxide (SiO₂) produced using a sol-gel method is provided between the core layer 11 and the clad layer 13, and the clad layer 12, the core layer 11, the protective layer 18, and the clad layer 13 are laminated together. Constituent elements other than what has been described above are fully identical to those of the above-described optical switch 1 and thus will not be described again.

The element was produced by using TiO₂ for the core layer 11, an FTC dye-containing non-linear optic polymer (the electro-optic coefficient r₃₃=150 μm/V when the polling treatment was carried out in single-layer film shapes) for the clad layers 12 and 13, and silicon oxide produced using a sol-gel method for the protective layer 18 and setting the thickness of the non-optical waveguide region 11b to 0.15 μm, the thickness and width of the optical waveguide region 11a to 0.30 μm and 2.0 μm respectively, the thickness of the clad layer 12 to 1.3 μm, the thickness of the clad layer 13 to 2.5 μm, and the thickness of the protective layer 18 to 0.3 μm, the polling treatment was carried out, and the electro-optic coefficients r₃₃ of the clad layers 12 and 13 were estimated from the modulation characteristics of the element and were found to be 120 μm/V which is 80% of the intrinsic material characteristics. It has been confirmed that a favorable polling treatment was carried out.

In addition, as Vπ·L (the product between the half-wavelength voltage and the length of the active portion electrode) which is a figure of merit of modulation, a favorable modulation efficiency of 3.7 V·cm was obtained, and operation in broadband bandwidths of 50 GHz or higher was also confirmed.

Even in the active portion 17 having this microstrip-type electrode constitution of the optical switch, it is possible to exhibit the same effects as in the above-described optical waveguide (active portion) 4 in the optical switch 1.

Furthermore, since the protective layer 18 made of silicon oxide (SiO₂) produced using a sol-gel method is provided between the core layer 11 and the clad layer 13, the protective layer 18 is capable of protecting the organic dielectric material having an electro-optic effect which constitutes the clad layer 13 from damage during element production processes such as dissolution by chemicals during the lamination and formation of films and reactions between materials. As a result, it is possible to increase the electro-optic coefficient of the clad layer 13 and to decrease the refractive index dispersion and the permittivity dispersion. Therefore, it is possible to carry out high-speed modulation even in high-frequency bands higher than 10 GHz.

Here, an example in which the protective layer 18 is formed between the clad layer 13 and the core layer 11 has been illustrated in the drawings; however, depending on the production processes of the element, the protective layer may be formed between the clad layer 12 and the core layer 11, or the protective layers which are made of a suitable material and have suitable thicknesses may be formed between the clad layer 12 and the core layer 11 and between the clad layer 13 and the core layer 11. In addition, the protective layers may be used in order to improve adhesion of the clad layers 12 and 13 to the core layer 11.

Meanwhile, a thin thickness of the protective layer 18 enables to obtain the efficiency of the element; however, even in a case in which the protective layer is as thick as the clad layer, a practical efficiency can be obtained. In addition, the protective layer can also be used as one of silicon oxide (SiO₂) clad layers 12 and 13 produced using a sol-gel method.

FIG. 4 is a sectional view illustrating a modification example of the optical waveguide structure (active portion) 4 of the optical switch 1 of the present embodiment. A difference of an active portion 21 having this microstrip-type electrode constitution of the optical switch from the above-described optical waveguide structure (active portion) 4 in the optical switch 1 is that, while, in the above-described optical waveguide structure (active portion) 4, the core layer 11 is a thin film in which the film thickness of the optical waveguide region 11a is increased in a strip shape in a direction toward the electrode layer 15 so as to be thicker than the film thickness of the non-optical waveguide region 11b which is the region other than the optical waveguide region 11a, in the active portion 21 having the microstrip-type electrode constitution, the film thickness of an optical waveguide region 22a in a core layer 22 is increased in a strip shape in a direction toward the electrode layer 16 so as to be thicker than the film thickness of a non-optical waveguide region 22b which is the region other than the optical waveguide region 22a, and an optical waveguide structure portion 23 is provided with a laminate structure in which the core layer 22 is sandwiched by a pair of the clad layers 12 and 13. Constituent elements other than what has been described above are fully identical to those of the above-described optical switch 1 and thus will not be described again.

Even in the active portion 21 having the microstrip-type electrode constitution of the optical switch, it is possible to exhibit the same effects as in the above-described optical waveguide (active portion) 4 in the optical switch 1.

Furthermore, since the film thickness of the optical waveguide region 22a in the core layer 22 is increased in a strip shape in a direction toward the electrode layer 16, it is possible to further improve the electric field efficiency.

In addition, the film thickness of the optical waveguide region 22a in the core layer 22 may be increased in a strip shape in both directions toward the electrode layer 15 and the electrode layer 16, and the same effects can be obtained.

### Second Embodiment

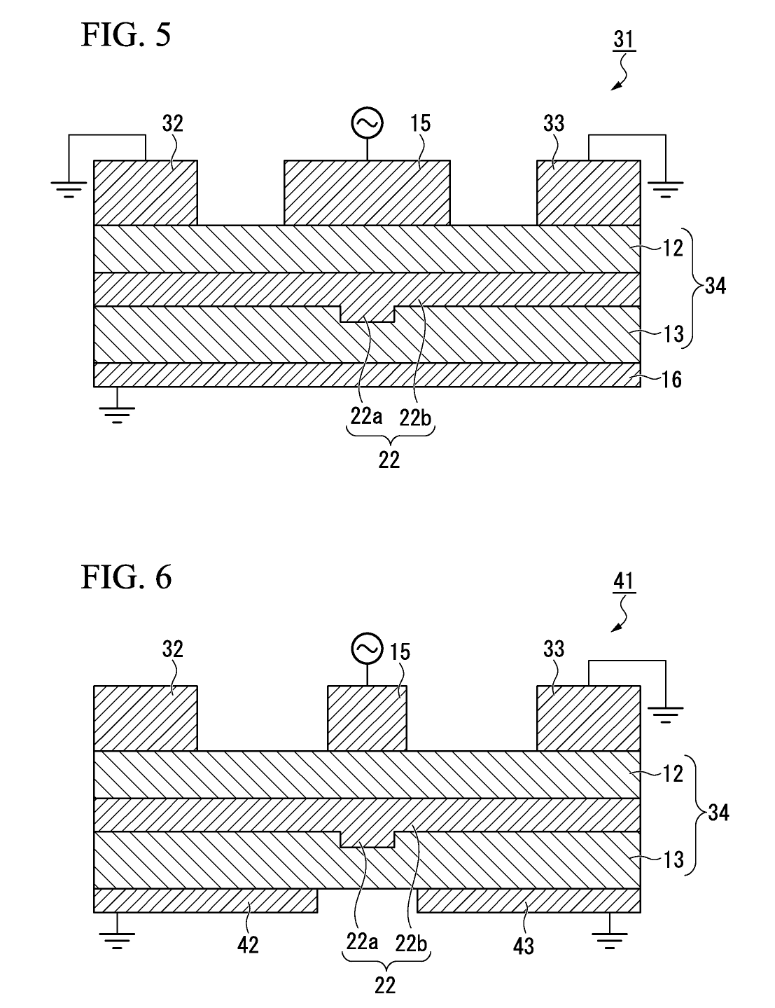

FIG. 5 is a sectional view illustrating the space arrangement of optical waveguides and electrodes in an electro-optic element of a second embodiment of the present invention and is an example of an optical switch having an electrode with a G-CPW line as the electro-optic element.

A difference of an active portion 31 having this G-CPW-type electrode constitution of the optical switch from the above-described optical waveguide structure (active portion) 4 in the optical switch 1 is that, while, in the above-described optical waveguide structure (active portion) 4, the film thickness of the optical waveguide region 11a in the core layer 11 is increased in a strip shape in a direction toward the electrode layer 15 so as to be thicker than the film thickness of the non-optical waveguide region lib, and the strip-shaped electrode layer 15 and the electrode layer 16 made of a planar electrode are formed so as to sandwich the core layer 11, the clad layer 12, and the clad layer 13, in the active portion 31 having this G-CPW-type electrode constitution, the film thickness of the optical waveguide region 22a in the core layer 22 is increased in a strip shape in a direction toward the electrode layer 16 so as to be thicker than the film thickness of the non-optical waveguide region 22b, an optical waveguide structure portion 34 is provided with a laminate structure in which the core layer 22 is sandwiched by a pair of the clad layers 12 and 13, and furthermore, earth electrode layers 32 and 33 which have the same potential (earth potential) as the electrode layer 16 and are disposed in a coplanar strip shape are formed on the clad layer 12 so as to sandwich the electrode layer 15. Constituent elements other than what has been described above are fully identical to those of the above-described optical switch 1 and thus will not be described again.

Even in the active portion 31 having this G-CPW-type electrode constitution of the optical switch, by applying a voltage between the electrode layer 15 and the electrode layers 32 and 33 to apply an electric field is applied to the optical waveguide structure portion 34 as a G-CPW line, it is possible to control any one or both of the phase and mode shape of light propagating through the optical waveguide structure portion 34.

Furthermore, since the G-CPW line has a high degree of freedom in designing characteristics such as the characteristic impedances of the line or refractive indices (propagation velocities) of high-frequency signals, even in a case in which dielectric material having high permittivity are used for the core layer 11, it is possible to enhance response with respect to high frequencies. When the G-CPW line is used, it is also possible to prevent the generation of high-order modes or radiation which are generated in microstrip line.

FIG. 6 is a sectional view illustrating a modification example of an electrode structure of the active portion 31 having the G-CPW-type electrode constitution of the optical switch which is the electro-optic element of the present embodiment. A difference of an active portion 41 having the G-CPW-type electrode constitution of the optical switch from the active portion 31 having the above-described G-CPW-type electrode constitution of the optical switch is that, while, in the active portion 31 having the above-described G-CPW-type electrode constitution, the electrode layer 16 made of the planar electrode is formed, in the active portion 41 having the G-CPW-type electrode constitution, a region in the electrode layer made of the planar electrode which corresponds to the optical waveguide region 22a in the core layer 22 is selectively removed, thereby disposing earth electrode layers 42 and 43 in a slotline shape or a coplanar stripline shape. Constituent elements other than what has been described above are fully identical to those of the active portion 31 having the G-CPW-type electrode constitution of the optical switch and thus will not be described again.

Even in the active portion 41 having this G-CPW-type electrode constitution of the optical switch, it is possible to exhibit the same effects as in the active portion 31 having the above-described G-CPW-type electrode constitution of the optical switch.

Furthermore, since the earth electrode layers 42 and 43 disposed in a slotline shape or a coplanar strip shape are formed as the earth electrodes, it is possible to further improve the degree of freedom in designing for adjusting characteristic impedances, particularly, the degree of freedom in designing which increases impedances. While the overlap integral factor between the optical electric field of light propagating through the optical waveguide structure portion 34 and an external electric field slightly decreases compared with a case in which the earth electrodes are not cut out, the overlap integral factor is sufficiently high in practical use. In addition, even when the earth electrodes are cut out in a mesh shape instead of a slotline shape or a coplanar strip shape, similarly, it is possible to further improve the degree of freedom in designing for adjusting characteristic impedances.

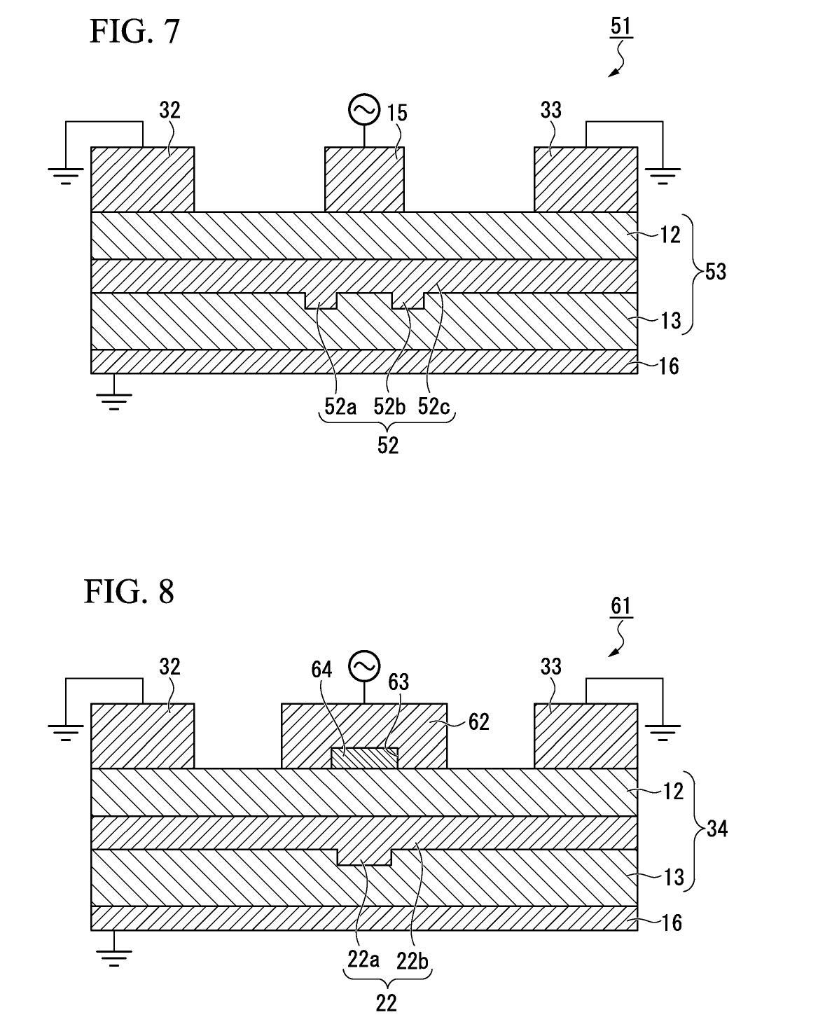

FIG. 7 is a sectional view illustrating a modification example of the optical waveguide structure (active portion) 31 having the G-CPW-type electrode constitution of the optical switch which is the electro-optic element of the present embodiment. A difference of an element 51 having this G-CPW-type electrode constitution of the optical switch from the active portion 31 having the above-described G-CPW-type electrode constitution of the optical switch is that, while, in the active portion 31 having the above-described G-CPW-type electrode constitution, the film thickness of one optical waveguide region 22a is increased in a strip shape in a direction toward the electrode layer 16 so as to be thicker than the film thickness of the non-optical waveguide region 22b, in the active portion 51 having this G-CPW-type electrode constitution, optical waveguide regions 52a and 52b are formed by increasing the film thickness in a strip shape in a direction toward the electrode layer 16 at locations corresponding to both side portions of the strip-shaped electrode layer 15 in the core layer 52, whereby the optical waveguide regions are set to be thicker than the film thickness of the non-optical waveguide region 52c which is a region other than the optical waveguide regions 52a and 52b, and an optical waveguide structure portion 53 is provided with a laminate structure in which the core layer 52 is sandwiched by a pair of the clad layers 12 and 13. Constituent elements other than what has been described above are fully identical to those of the element 31 having the G-CPW-type electrode constitution of the optical switch and thus will not be described again.

Even in the element 51 having this G-CPW-type electrode constitution of the optical switch, it is possible to exhibit the same effects as in the element 31 having the above-described G-CPW-type electrode constitution of the optical switch.

Furthermore, since the optical waveguide regions 52a and 52b having film thicknesses increased in a strip shape in a direction toward the electrode layer 16 are formed at the locations corresponding to both side portions of the strip-shaped electrode layer 15 in the core layer 52, it becomes possible to extend portions having a greater optical electric field distribution of light propagating through the optical waveguide structure portion 53 in a single mode into the clad layer 13 portion, and the efficiency of the element can be increased. In addition, since it is possible to decrease the entire thickness of the clad layer 12, the core layer 52, and the clad layer 13, the impedance as the active portion 31 having the G-CPW-type electrode constitution can be set within a predetermined range. Therefore, it is possible to further improve the electric field efficiency.

Furthermore, when a plurality of strip-shaped regions are provided to the core layer 52, the degree of freedom in designing structure dispersion characteristics as optical waveguides significantly improves. For example, when the structure dispersion of optical waveguides is reduced, the wavelength dependency of the characteristics of the element can be reduced, and it is possible to realize optical modulation elements or switching elements corresponding to broadband wavelength bands. In contrast, when the structure dispersion is enlarged, the functions of compensation of optical signal dispersions, wavelength-selective switches and the like can be realized. It is needless to say that the number of the portions in which the film thickness of the core layer 52 is increased is not limited to two, as the number thereof increases, optical waveguides and the degree of freedom in designing characteristics increase, and the orientation in which the film thickness extends is not limited to one orientation.

FIG. 8 is a sectional view illustrating a modification example of an electrode structure of the active portion 31 having the G-CPW-type electrode constitution of the optical switch which is the electro-optic element of the present embodiment. A difference of an active portion 61 having this G-CPW-type electrode constitution of the optical switch from the active portion 31 having the above-described G-CPW-type electrode constitution of the optical switch is that, while, in the active portion 31 having the above-described G-CPW-type electrode constitution, the electrode layer 15 is made of a conductive material, in the active portion 61 having this G-CPW-type electrode constitution, a strip-shaped recess portion 63 opening on the clad layer 12 side is formed in an electrode layer 62 made of a conductive material, and the recess portion 63 is filled with a low-permittivity material 64, for example, air, Benzo-Cyclo-Butene (BCB) which is a low-dielectric loss material, SiO₂, or the like. Constituent elements other than what has been described above are fully identical to those of the active portion 31 having the G-CPW-type electrode constitution of the optical switch and thus will not be described again.

Even in active portion 61 having this G-CPW-type electrode constitution of the optical switch, it is possible to exhibit the same effects as in the active portion 31 having the above-described G-CPW-type electrode constitution of the optical switch.

Furthermore, since the strip-shaped recess portion 63 is formed in the electrode layer 62 made of a conductive material, and the recess portion 63 is filled with the low-permittivity material 64, it is possible to improve the degree of freedom in designing active portion 61 having the G-CPW-type electrode constitution by selecting the low-permittivity material to be used for filling the recess portion.

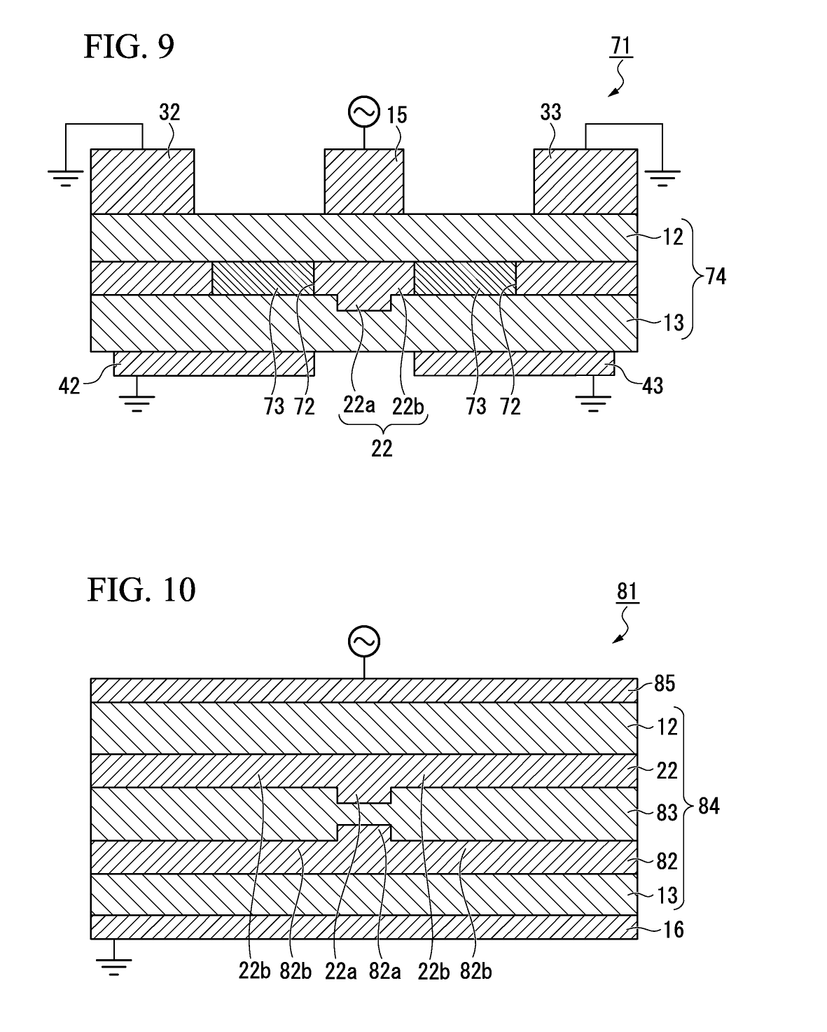

FIG. 9 is a sectional view illustrating a modification example of the optical waveguide structure (active portion) 31 having the G-CPW-type electrode constitution of the optical switch which is the electro-optic element of the present embodiment. A difference of an active portion 71 having this G-CPW-type electrode constitution of the optical switch from the active portion 31 having the above-described G-CPW-type electrode constitution of the optical switch is that, while, in the active portion 31 having the above-described G-CPW-type electrode constitution, the film thickness of the optical waveguide region 22a is increased in a strip shape in a direction toward the electrode layer 16 so as to be thicker than the film thickness of the non-optical waveguide region 22b, in the active portion 71 having this G-CPW-type electrode constitution, the electrode layer 16 made of a planar electrode is formed into the earth electrode layers 42 and 43 disposed in a coplanar strip shape or a slotline shape, strip-shaped opening portions 72 are formed along the optical waveguide region 22a and the non-optical waveguide region 22b in regions other than regions corresponding to the electrode layers 15, 32, and 33, in other words, regions outside the optical waveguide region 22a and the non-optical waveguide region 22b in the core layer 22, these opening portions 72 are filled with a dielectric material 73, and an optical waveguide structure portion 74 is provided with a laminate structure in which the core layer 22 is sandwiched by a pair of the clad layers 12 and 13. Constituent elements other than what has been described above are fully identical to those of the active portion 31 having the G-CPW-type electrode constitution of the optical switch or active portion 41 which is a modification thereof and thus will not be described again.

The dielectric material 73 is preferably a dielectric material containing an organic dielectric material having an electro-optic effect. The organic dielectric material having an electro-optic effect is preferably a non-linear optic organic compound. The non-linear optic organic compound is preferably the above-described non-linear optic organic compound (1) or (2).

Even in the active portion 71 having this G-CPW-type electrode constitution of the optical switch, it is possible to exhibit the same effects as in the active portion 31 having the above-described G-CPW-type electrode constitution of the optical switch.

Furthermore, in a case in which the opening portions 72 are filled with an organic dielectric material having an electro-optic effect as the dielectric material 73, the electro-optic effect of propagating light portions leaking to the opening portions 72 becomes effective, and thus the efficiency of the element further improves.

Furthermore, when the opening portions 72 are provided in the core layer for which a material having high permittivity such as TiO₂, Nb₂O₅, and Ta₂O₅ is used, the constituent ratio of portions having high permittivity decreases, and parts of the earth electrodes are cut out, thereby forming the earth electrode layers 42 and 43 disposed in a coplanar strip shape or a slotline shape, and thus it is possible to further improve the degree of freedom in designing characteristic impedances, particularly, the degree of freedom in designing for increasing impedances.

### Third Embodiment

FIG. 10 is a sectional view illustrating an optical waveguide in an electro-optic element of a third embodiment of the present invention and is an example of a stacked coupler-type optical switch having a multilayer structure as this electro-optic element.

A difference of this laminate-structure optical waveguide switch 81 from the active portion 31 having the G-CPW-type electrode constitution illustrated in FIG. 5 is that, while, in the active portion 31 having the above-described G-CPW-type electrode constitution, the optical waveguide structure portion 34 is provided with a laminate structure in which the core layer 22 including a strip-shaped optical waveguide region 22a and non-optical waveguide regions 22b on both sides thereof is sandwiched by a pair of the clad layers 12 and 13, and the electrode layer 15 with a G-CPW line, the electrode layers 32 and 33, and the electrode layer 16 made of a planar electrode are formed so as to sandwich the clad layer 12, the core layer 22, and the clad layer 13, in this laminate-structure optical waveguide switch 81, an optical waveguide structure portion 84 is constituted by disposing a core layer 82 which has the same composition as the core layer 22 and includes a strip-shaped optical waveguide region 82a and non-optical waveguide regions 82b on both sides thereof so as to face the core layer 22 including the strip-shaped optical waveguide region 22a and the non-optical waveguide regions 22b on both sides thereof through a third clad layer 83 having the same composition as the clad layers 12 and 13 and stacking the clad layer 12, the core layer 22, the clad layer 83, the core layer 82, and the clad layer 13, and the electrode layer 16 and an electrode layer 85 made of a planar electrode having the same composition as the electrode layer 16 are formed so as to sandwich the clad layer 12 through the clad layer 13.

In this laminate-structure optical waveguide switch 81, a ferroelectric polarization orientation 93 in the clad layer 12, a ferroelectric polarization orientation 94 in the clad layer 83, and a ferroelectric polarization orientation 95 in the clad layer 13 are set to the same orientation.

Even in this laminate-structure optical waveguide switch 81, by applying a voltage between the electrode layer 85 and the electrode layer 16 at earth potential to apply an electric field to the optical waveguide structure portion 84, it is possible to control any one or both of the phase and mode shape of light propagating through the optical waveguide region 22a in the core layer 22 and the optical waveguide region 82a in the core layer 82 in the optical waveguide structure portion 84.

Here, when a voltage is applied between the electrode layer 85 and the electrode layer 16 at earth potential, the respective effective refractive indices of the optical waveguide region 22a and the optical waveguide region 82a change; however, when the applied voltage is high, the mode diameters of light respectively propagating through the optical waveguide region 22a and the optical waveguide region 82a change. Using this phenomenon, it is possible to carry out modulation operations or switching operations of light.

When a voltage is applied between the electrode layer 85 and the electrode layer 16 at earth potential so that the mode diameters of light respectively propagating through the optical waveguide region 22a and the optical waveguide region 82a become large, in other words, the optical confinement of modes respectively propagating therethrough become weak, the optical waveguide region 22a and the optical waveguide region 82a function not as independent parallel waveguides but as a coupler as a directional coupler. The degree of coupling (coupling factor) can be controlled using a voltage being applied, and it is possible to realize a switching function for switching optical waveguide regions through which light propagate. When the optical waveguide regions are preset to function as a directional coupler in a state without applied voltage in advance, and a voltage is applied between the electrode layer 85 and the electrode layer 16 at earth potential, it is possible to operate to switch optical paths by setting the mode diameters of light respectively propagating through the optical waveguide region 22a and the optical waveguide region 82a to become small, in other words, setting the optical confinement of modes respectively propagating therethrough to become strong. When the materials or thicknesses of the core layers 22 and 82, the materials, shapes, or sizes of the optical waveguide region 22a and the optical waveguide region 82a, and the materials or thicknesses of the clad layers 12, 13, and 83 are appropriately changed, it is possible to adjust the degree of coupling the optical waveguide region 22a and the optical waveguide region 82a and control the degree of coupling using the voltage between the electrode layer 85 and the electrode layer 16 at earth potential.

FIG. 10 illustrates a case in which both the electrode layer 85 and the electrode layer 16 which at earth potential have planar shapes, but the constitutions of the electrodes may be the microstrip-type electrode constitution illustrated in FIG. 2 or the G-CPW-type electrode constitution illustrated in FIG. 5, which is advantageous for the efficiency or high-frequency operation of the element. This effect is completely the same as that described in the first embodiment and the second embodiment and thus will not be described again. In addition, FIG. 10 illustrates a case of the optical waveguide region in which two layers are stacked together, but the switching operation may be carried out in three or more layer-stacked constitutions.

### INDUSTRIAL APPLICABILITY

According to the electro-optic element of the present invention, it is possible to carry out high-speed modulation even in high-frequency bands higher than 10 GHz. In addition, it is possible to achieve the integration, miniaturization, and power consumption reduction of the electro-optic element, and thus the present invention is industrially useful.

### REFERENCE SIGNS LIST

1 optical switch

2 optical waveguide (incidence side)

3 optical branching portion

4, 5 optical waveguide (active portion)

6, 7 electrode

8 optical branching and multiplexing portion

9, 10 optical waveguide (emission side)

11 core layer

11a optical waveguide region

11b non-optical waveguide region

12 first clad layer

13 second clad layer

14 optical waveguide structure portion

15 first electrode layer

16 second electrode layer

17 active portion having microstrip-type electrode constitution

18 protective layer

19 optical waveguide structure portion

21 active portion having microstrip-type electrode constitution

22 core layer

22a optical waveguide region

22b non-optical waveguide region

23 optical waveguide structure portion

31 active portion having G-CPW-type electrode constitution

32, 33 earth electrode layer disposed in coplanar strip shape

34 optical waveguide structure portion

41 active portion having G-CPW-type electrode constitution

42, 43 earth electrode layer disposed in slotline shape or coplanar strip shape

51 active portion having G-CPW-type electrode constitution

52 core layer

52a, 52b optical waveguide region

52c non-optical waveguide region

53 optical waveguide structure portion

61 active portion having G-CPW-type electrode constitution

62 electrode layer

64 material having low permittivity

71 active portion having G-CPW-type electrode constitution

73 dielectric material

74 optical waveguide structure portion

81 laminate-structure optical waveguide switch

82 core layer

82a optical waveguide region

83 third clad layer

84 optical waveguide structure portion

85 electrode layer cm 1. An electro-optic element comprising:
an optical waveguide that is constituted of a core layer made of an inorganic compound and a first clad layer and a second clad layer which are laminated so as to sandwich the core layer therebetween and are made of a dielectric material; and
a first electrode layer and a second electrode layer that are formed so as to sandwich the core layer therebetween, the first clad layer, and the second clad layer, wherein
the first clad layer and the second clad layer contain an organic dielectric material having an electro-optic effect,
refractive indices of the first clad layer and the second clad layer are lower than a refractive index of the core layer,
the core layer includes an optical waveguide region and a non-optical waveguide region which is other than the optical waveguide region,
the optical waveguide region is increased in a strip shape in at least one direction toward the first electrode layer and toward the second electrode layer so as to be thicker than the non-optical waveguide region,
film thicknesses of the first clad layer and the second clad layer are thicker than a film thickness of the optical waveguide region, and
in a cross section which crosses the optical waveguide region included in the optical waveguide, widths of the first clad layer and the second clad layer are wider than a width of the optical waveguide region and the first electrode layer and the second electrode layer are wider than a width of the optical waveguide region.

2. (canceled)

3. The electro-optic element according to claim 1,
wherein the inorganic compound contains one or two or more selected from the group consisting of titanium oxide, silicon nitride, niobium oxide, tantalum oxide, hafnium oxide, aluminum oxide, silicon, diamond, lithium niobate, lithium tantalate, potassium niobate, barium titanate, KTN, STO, BTO, SBN, KTP, PLZT, and PZT.

4. The electro-optic element according to claim 1,
wherein the first electrode layer and the second electrode layer contain one or two more selected from the group consisting of gold, silver, copper, platinum, ruthenium, rhodium, palladium, osmium, iridium, and aluminum.

5. The electro-optic element according to claim 1,
wherein the organic dielectric material is a non-linear optic organic compound.

6. The electro-optic element according to claim 1,
wherein any one of the first electrode layer and the second electrode layer has a strip shape and
a voltage is applied between the first electrode layer and the second electrode layer, whereby an electric field is applied to the optical waveguide as a microstrip-type electrode or a stacked pair-type electrode, and any one or both of phase and mode shape of light propagating through the optical waveguide is controlled.

7. The electro-optic element according to claim 1,
wherein any one of the first electrode layer and the second electrode layer has a coplanar shape and
a voltage is applied between the first electrode layer and the second electrode layer, whereby an electric field is applied to the optical waveguide as a G-CPW-type electrode, and any one or both of the phase and mode shape of the light propagating through the optical waveguide is controlled.

8. The electro-optical element according to claim 3,
wherein the first electrode layer and the second electrode layer contain one or two or more selected from the group consisting of gold, silver, copper, platinum, ruthenium, rhodium, palladium, osmium, iridium, and aluminum.

9. The electro-optical element according to claim 3,
wherein the organic dielectric material is a non-linear optical organic compound.

10. The electro-optical element according to claim 4,
wherein the organic dielectric material is a non-linear optical organic compound.

11. The electro-optical element according to claim 3,
wherein any one of the first electrode layer and the second electrode layer has a strip shape and
a voltage is applied between the first electrode layer and the second electrode layer, whereby an electric field is applied to the optical waveguide as a microstrip-type electrode or a stacked pair-type electrode, and any one or both of phase and mode shape of light propagating through the optical waveguide is controlled.

12. The electro-optical element according to claim 4,
wherein any one of the first electrode layer and the second electrode layer has a strip shape and
a voltage is applied between the first electrode layer and the second electrode layer, whereby an electric field is applied to the optical waveguide as a microstrip-type electrode or a stacked pair-type electrode, and any one or both of phase and mode shape of light propagating through the optical waveguide is controlled.

13. The electro-optical element according to claim 5,
wherein any one of the first electrode layer and the second electrode layer has a strip shape and
a voltage is applied between the first electrode layer and the second electrode layer, whereby an electric field is applied to the optical waveguide as a microstrip-type electrode or a stacked pair-type electrode, and any one or both of phase and mode shape of light propagating through the optical waveguide is controlled.

14. The electro-optical element according to claim 3,
wherein any one of the first electrode layer and the second electrode layer has a coplanar shape and
a voltage is applied between the first electrode layer and the second electrode layer, whereby an electric field is applied to the optical waveguide as a G-CPW-type electrode, and any one or both of the phase and mode shape of the light propagating through the optical waveguide is controlled.

15. The electro-optical element according to claim 4,
wherein any one of the first electrode layer and the second electrode layer has a coplanar shape and
a voltage is applied between the first electrode layer and the second electrode layer, whereby an electric field is applied to the optical waveguide as a G-CPW-type electrode, and any one or both of the phase and mode shape of the light propagating through the optical waveguide is controlled.

16. The electro-optical element according to claim 5,
wherein any one of the first electrode layer and the second electrode layer has a coplanar shape and
a voltage is applied between the first electrode layer and the second electrode layer, whereby an electric field is applied to the optical waveguide as a G-CPW-type electrode, and any one or both of the phase and mode shape of the light propagating through the optical waveguide is controlled.
